(19) United States
(12) Patent Application Publication
(10) Pub. No.: US 2011/0222145 A1
(43) Pub. Date: Sep. 15, 2011

(54) OPTICAL LAMINATED PRODUCT AND FITTING

(75) Inventor: Hiroyuki Ito, Miyagi (JP)

(73) Assignee: SONY CORPORATION, Tokyo (JP)

(21) Appl. No.: 13/041,954

(22) Filed: Mar. 7, 2011

(30) Foreign Application Priority Data
Mar. 15, 2010 (JP) P2010-056934

(51) Int. Cl. G02B 5/26; G02B 5/08; G02B 27/14

(52) U.S. Cl. 359/359; 359/883; 359/634

(57) ABSTRACT

An optical laminated product includes a first transmissive base member, a second transmissive base member, and a structured layer. The second transmissive base member faces the first transmissive base member. The structured layer is arranged between the first transmissive base member and the second transmissive base member, and configured to perform directional reflection of light which forms part of light passed through the second transmissive base member.

### CROSS REFERENCES TO RELATED APPLICATIONS

The present application claims priority to Japanese Patent Application JP 2010-056934 filed on Mar. 15, 2010, the entire contents of which is hereby incorporated by reference.

### BACKGROUND

The present disclosure relates to an optical laminated product and a fitting, each of which is configured to selectively reflect, for example, infrared light, and to have visible light passed therethrough.

In recent years, there has been increasing the number of cases in which architectural window glass of high-rise buildings, residential house and the like, and vehicular glass are provided with a layer configured to partially absorb or reflect sunlight. This structure, provided as one of energy efficiency measures for preventing global warming, can reduce load of air conditioner by suppressing the rise of room temperature resulting from near-infrared light passing through the window from the sun, for example.

As one example of the structure configured to filter out near-infrared light while maintaining a light transmissive property in the range of visible light, there is known a structure in which a layer having a high reflectance in the range of near-infrared light is provided on a laminated window glass. A laminated window glass in which an infrared reflective film is sandwiched between an outside glass plate and an inside glass plate, and has a laminated structure of a high refractive index film made of inorganic material and a low refractive index film made of inorganic material, is disclosed in, for example, Japanese Patent Application Laid-Open Publication No. 2008-37667.

### SUMMARY

However, the structure disclosed in Japanese Patent Application Laid-Open Publication No. 2008-37667 can perform only regular reflection of light from the sun, by reason that a reflection layer is provided on a flat window glass. Therefore, after the regular reflection of light from the sky, the reflected light is absorbed by other buildings and the ground, and transformed into heat to cause the rise of surrounding temperature.

In view of the circumstances as described above, it is desirable to provide an optical laminated product that can filter out near-infrared light to suppress the rise of surrounding temperature.

According to an embodiment, there is provided an optical laminated product including a first transmissive base member, a second transmissive base member, and a structured layer.

The second transmissive base member faces the first transmissive base member.

The structured layer is arranged between the first transmissive base member and the second transmissive base member. The structured layer is configured to perform directional reflection of light which forms part of light passed through the second transmissive base member.

Because the structured layer has a directional reflection structure, for example, the optical laminated product has spectroscopic property in the first wavelength band different from that in the second wavelength band to perform directional reflection in the incident direction of light in the first wavelength band. Therefore, under the condition that, for example, an infrared band is defined as the first wavelength band, the optical laminated product can suppress the rise of surrounding temperature in comparison with a product configured to perform regular reflection of incident light. Further, it is possible to ensure daylighting excellent in visibility while suppressing the rise of surrounding temperature, under the condition that a visible band is defined as the second wavelength band. For example, a product provided with only a semi-reflecting layer does not have wavelength selectivity, but it is possible to form a directional reflection layer at low cost. Because the above structured layer is sandwiched between two transmissive base members, the structured layer is improved in durability and weather resistance.

The structured layer has a light-transmissive body and an optical function layer. The optical function layer is a layer configured to partially reflect the incident light, for example, a semi-transmissive layer or a wavelength selective reflection layer. The light-transmissive body has a first surface on which directional reflective concave sections are arranged. The optical function layer is formed on the first surface, and configured to reflect light in the first wavelength band, and to have light passed therethrough in the second wavelength band.

In this way, the structured layer can be formed separately from the first and second transmissive base members. Accordingly, the structured layer can be manufactured with ease.

The recursive reflective concave section may have the shape of prism, cylindrical lens, or the like one-dimensionally arranged on a first surface. The recursive reflective concave section may have the shape of pyramid, curved surface, or the like two dimensionally arranged on the first surface. The light-transmissive body may be made of for example ultraviolet curable resin, and the concave section and the light-transmissive body may be formed at the same time.

The optical multiple films may have dielectric material such as metal-oxide film, and metal. Material, thickness, and the number of each of the optical multiple films are set arbitrarily on the basis of the wavelength band of light to be blocked, transmittance (reflectance), and the like.

The light-transmissive body may further have a second surface defined on the opposite side of the first surface. The optical laminated product may further include a first transmissive adhesion layer configured to have the second surface adhered to the first transmissive base member.

Therefore, the structured layer can be integrally formed with the first transmissive base member. The first transmissive adhesion layer may be composed of thermoplastic resin, ultraviolet curable resin, adhesive tape, or the like.

The optical laminated product may further have a second transmissive adhesion layer configured to have the structured layer adhered to the second transmissive base member.

Therefore, the structured layer can be integrally formed with the second transmissive base member. Further, because the structured layer is sealed between the first and second transmissive base members, it is possible to enhance the structured layer in durability.

In place of the above configuration, the optical laminated product may further have an inactive gas layer sealed between the structured layer and the second transmissive base member.

According to the embodiment, it is possible to provide an optical laminated product configured to filter out near-infrared light without, for example, a rise in surrounding temperature, and to have excellent durability.

Additional features and advantages are described herein, and will be apparent from the following Detailed Description and the figures.

### BRIEF DESCRIPTION OF THE FIGURES

FIG. 1 is a fragmentary schematic cross-sectional view of an optical laminated product according to the first embodiment;

FIG. 2 is a fragmentary perspective view showing one example of configuration of a light-transmissive body of the above optical laminated product;

FIG. 3 is a fragmentary perspective view showing another example of configuration of a light-transmissive body of the above optical laminated product;

FIG. 4 is a fragmentary plan view showing further example of configuration of the light-transmissive body of the above optical laminated product;

FIG. 5 is a cross-sectional view for explaining one operation of the above optical laminated product;

FIG. 6 are cross-sectional views of each process for explaining a method of producing an optical laminated product according to one embodiment;

FIG. 7 is a cross-sectional view for explaining a method of producing an optical laminated product according to one embodiment;

FIG. 8 is a fragmentary schematic cross-sectional view of an optical laminated product produced on the basis of the above producing method;

FIG. 9 is a fragmentary schematic cross-sectional view of an optical laminated product according to the second embodiment;

FIG. 10 is a fragmentary schematic cross-sectional view of an optical laminated product according to the third embodiment;

FIG. 11 is a fragmentary schematic cross-sectional view of an optical laminated product according to the fourth embodiment;

FIG. 12 is a schematic cross-sectional view of a main section showing one example of configuration of a mold tool for producing the above light-transmissive body;

FIG. 13 is a perspective view showing relationship between incident light entering an optical laminated product and light reflected by the optical laminated product, according to a modified example of the embodiment;

FIG. 14A is a cross-sectional view showing one example of configuration of the optical laminated product according to a modified example of the embodiment;

FIG. 14B is a perspective view showing one example of configuration of a structure of the optical laminated product according to a modified example of the embodiment;

FIG. 15A is a perspective view showing an example of the shape of a structure formed on a shaped layer, according to a modified example of the embodiment;

FIG. 15B is a cross-sectional view showing an inclination direction of a main axis of the structure formed on the shaped layer, according to a modified example of the embodiment;

FIG. 16 are cross-sectional view showing an example in configuration of an optical laminated product according to a modified example of the embodiment;

FIG. 17 are perspective view showing an example in configuration of a shaped layer of an optical laminated product according to a modified example of the embodiment;

FIG. 18A is a plan view showing an example in configuration of the shaped layer of the optical laminated product, according to the modified example;

FIG. 18B is a cross-sectional view along the line B-B of the shaped layer shown in FIG. 18A, according to the modified example;

FIG. 18C is a cross-sectional view along the line C-C of the shaped layer shown in FIG. 18A, according to the modified example;

FIG. 19A is a plan view showing an example in configuration of the shaped layer of the optical laminated product, according to the modified example;

FIG. 19B is a cross-sectional view along the line B-B of the shaped layer shown in FIG. 19A, according to the modified example;

FIG. 19C is a cross-sectional view along the line C-C of the shaped layer shown in FIG. 19A, according to the modified example; and

FIG. 20 is a perspective view showing an example in configuration of a fitting according to an embodiment.

### DETAILED DESCRIPTION

Hereinafter, embodiments will be described with reference to accompanying drawings.

### First Embodiment

[Configuration of Optical Laminated Product]

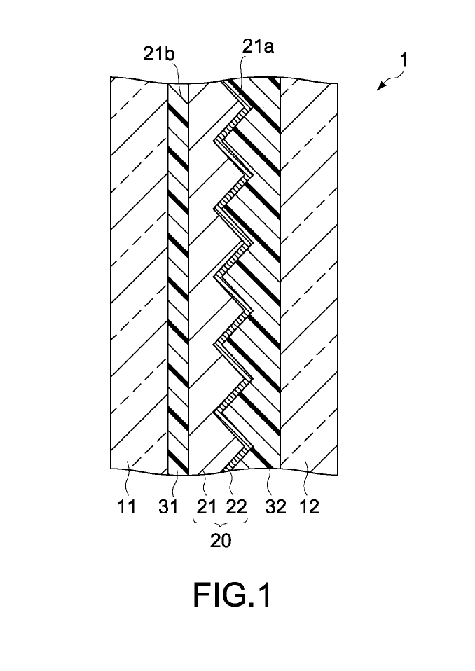

FIG. 1 is a cross-sectional view of a main section showing an optical laminated product according to one embodiment. In this embodiment, an optical laminated product 1 has a first transmissive base member 11, a second transmissive base member 12, and a structured layer 20 arranged between the first transmissive base member 11 and the second transmissive base member 12. The optical laminated product 1 is used as each window of building or vehicle. Additionally, in the drawings, each section is overdrawn in size, thickness, and the like for simplicity's sake.

Hereinafter, each section of the optical laminated product 1 will be described in detail.

[Transmissive Base Member]

The first and second transmissive base members 11 and 12 are made of float glass which is, for example, 2.5 mm in thickness. Additionally, in place of glass, the first and second transmissive base members 11 and 12 may be made of light-transmissive plastic material such as acrylic plate and polycarbonate plate. The transmissive base members 11 and 12 are not limited to respective specific values in thickness, and are selectable from, for example, 1 mm to 3 mm in thickness.

Glass material to be used for the transmissive base members 11 and 12 may include an element such as Si (silicon), P (phosphorus), B (boron), Ca (calcium), Mg (magnesium), Nd (neodymium), Pb (lead), Zn (zinc), Cu (copper), Nb (niobium), Li (lithium), Fe (iron), Sr (strontium), Ba (barium), Ni (nickel), Ti (titanium), In (indium), K (potassium), Na (natrium), or Al (aluminum). Those elements are used as the situation demands.

Further, a liquid crystal layer may be applied to the surfaces of the transmissive base members 11 and 12. A liquid crystal material may be sealed in a gap between the transmissive base members 11 and 12. Further, functional pigment such as so-called “thermochromic material” (material which reversibly changes in color with heat), “electrochromic material” (material which reversibly changes in color with applied voltage) may be added to the transmissive base members 11 and 12.

[Structured Layer]

The structured layer 20 has a light-transmissive body 21 and an optical function layer 22 formed on the surface of the light-transmissive body 21.

(Light-Transmissive Body)

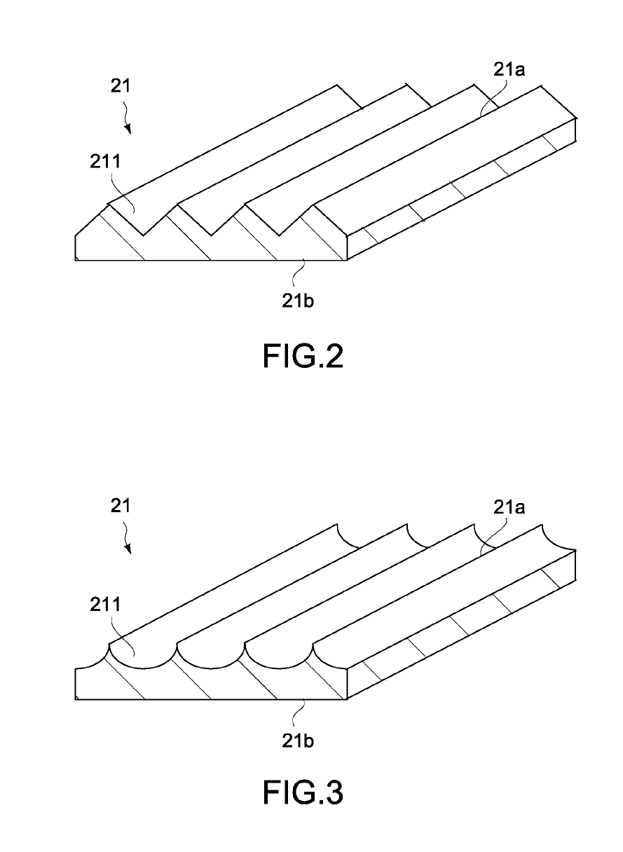

FIGS. 2 to 4 are perspective or plan views of main sections, each of which schematically shows a form of the light-transmissive body 21. The light-transmissive body 21 has a structured surface 21a (first surface) formed with an array of concave sections 211 on a surface defined on the same side as a surface on which the optical function layer 22 is formed. In the light-transmissive body 21, a rear surface 21b (second surface) opposite to the structured surface 21a is flat.

The concave sections 211 forming a structured surface 21a have a directional reflection structure. In this embodiment, each of the concave sections 211 is formed by a structure having a peak at the bottom of the relevant structure. The concave section 211 has the shape of, for example, pyramid, circular cone, prismatic column, curved surface, prism, cylinder, hemisphere, corner of a cube, and the like. The concave sections 211 are the same in shape and size as each other. On the other hand, the concave sections 211 may be periodically changed in shape and size, or differs from area to area in shape and size.

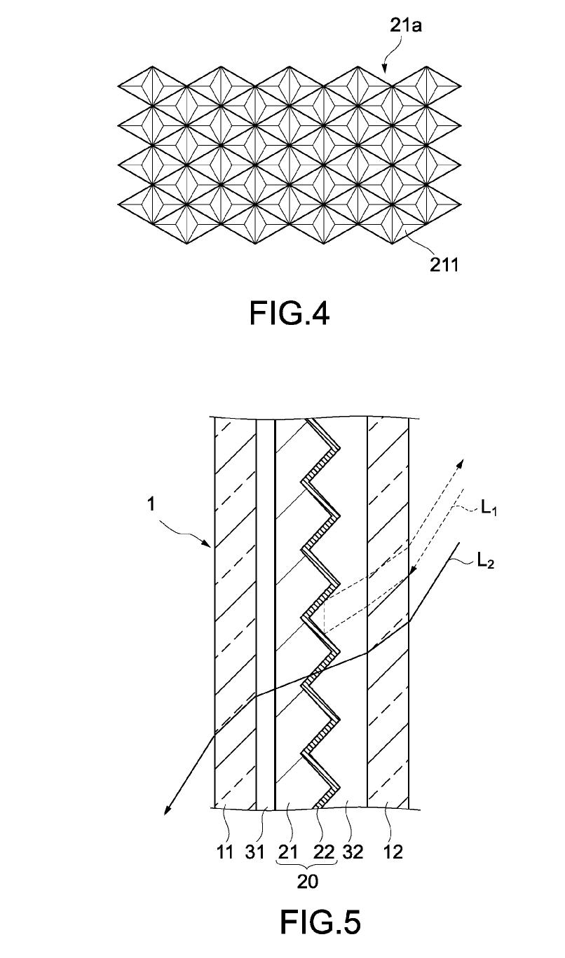

FIG. 2 is a fragmentary perspective view showing a structured surface in which triangular prism shaped (prism shaped) concave sections 211 arranged as one dimensional array. FIG. 3 is a fragmentary perspective view showing curved surface shaped (cylindrical lens shaped) concave sections 211 arranged as one dimensional array. FIG. 4 is a fragmentary plan view showing a structured surface in which triangular pyramid concave sections 211 are arranged as a two-dimensional array. A pitch of the concave sections 211 (i.e., distance between two peaks of concave sections 211 adjacent to each other) is not limited to a specific value, and may be selectable from, for example, tens of μm to hundreds of μm as necessary. Further, the depth of the concave sections 211 is not limited to a specific value, and may be selectable from, for example, 10 μm to 100 μm. The aspect ratio of the concave sections 211 (measurements in depth and square) is not limited to a specific value, and may be equal to or larger than 0.5.

The light-transmissive body 21 is formed of light-transmissive resin material such as thermoplastic resin, heat-curable resin, and energy beam curable resin. The light-transmissive body 21 is configured to function as a supporting member to support the optical function layer 22. The light-transmissive body 21 is formed into film, sheet, or plate, each of which is predefined in thickness.

The thermoplastic resin is exemplified by materials such as acrylic polymers such as polymethylmethacrylate; polycarbonate; cellulosic materials such as cellulose acetate, cellulose (acetate-co-butyrate), and cellulose nitrate; epoxy resins; polyesters such as polybutylene terephthalate and polyethylene terephthalate; fluoropolymers such as polychloro fluoroethylene and polyvinylidene fluoride; polyamides such as polycaprolactam, polyamino caproic acid, poly(hexamethylene diamine-co-adipic acid), poly(amide-co-imide), and poly(ester-co-imide); polyetherketones; polyetherimides; polyolefins such as polymethylpentene; polyphenylene ethers; polyphenylene sulfide; polystyrene and polystyrene copolymers such as poly(styrene-co-acrylonitrile), poly(styrene-co-acrylonitrile-co-butadiene); polysulfone; silicone modified polymers (i.e., polymers that contain a small weight percent (less than 10 weight percent) of silicone) such as silicone polyamide and silicone polycarbonate; fluorine modified polymers such as perfluoropoly(ethyleneterephthalate); and mixtures of the above polymers such as a polyester and polycarbonate blend, and a fluoropolymer and acrylic polymer blend.

The energy beam curable resin is classified into reactive resin system capable of being bridged by radical polymerization mechanism by exposure of electron beam, ultraviolet light, and visible light. Further, thermal initiator such as benzoyl peroxide may be added to those materials. In this case, the materials can be polymerized by a thermal means. Radiation-initiated cationically polymerizable resins may be used.

The reactive resin may be composed of photoinitator and at least one compound having an acrylate group, as a mixed resin. It is preferable that this resin include a difunctional or polyfunctional compound to ensure a cross-linked polymeric structure upon exposure. Some examples of resins capable of being polymerized by a free radical mechanism include acrylic-based resins derived from epoxies, polyesters, polyethers and urethanes, ethylenically-unsaturated compounds, aminoplast derivatives having at least one pendant acrylate group, isocyanate derivatives having at least one pendant acrylate group, epoxy resins other than acrylated epoxies, and mixtures and combinations thereof. Here, the term “acrylate” is used in the sense of both acrylates and methacrylates.

For example, both monomeric and polymeric compounds containing atoms of carbon, hydrogen and oxygen, and optionally containing nitrogen, sulfur and halogens are exemplified as ethylenically-unsaturated resin. Oxygen or nitrogen atoms, or both, are generally present in ether, ester, urethane, amide, and urea groups. Each ethylenically-unsaturated compound preferably has a molecular weight less than about 4,000, and preferably are esters made from the reaction of compounds containing aliphatic monohydroxy groups or aliphatic polyhydroxy groups, and unsaturated carboxylic acids such as acrylic acid, methacrylic acid, itaconic acid, crotonic acid, iso-crotonic acid, and maleic acid. Further, specific examples of compounds having an acrylic or methacrylic group are as follows, but ethylenically-unsaturated resin is not limited by the following examples.

(1) Monofunctional compound is exemplified by materials such as ethyl acrylate, n-butyl acrylate, isobutyl acrylate, 2-ethylhexyl acrylate, n-hexyl acrylate, n-octyl acrylate, isobornyl acrylate, tetrahydrofurfuryl acrylate, 2-phenoxyethyl acrylate, and N,N-dimethyl acrylamide.

(2) Difunctional compound is exemplified by materials such as 1,4-butanediol diacrylate, 1,6-hexanediol diacrylate, neopentylglycol diacrylate, ethylene glycol diacrylate, triethyleneglycol diacrylate, and tetraethylene glycol diacrylate.

(3) Polyfunctional compound is exemplified by materials such as trimethylolpropane triacrylate, glycerol triacrylate, pentaerythritol triacrylate, pentaerythritol tetraacrylate, and tris(2-acryloyloxyethyl)isocyanurate. Some representative examples of other ethylenically-unsaturated compounds and resins include styrene, divinylbenzene, vinyl toluene, N-vinyl pyrrolidone, N-vinyl caprolactam, monoallyl, polyallyl, and polymethallyl esters such as diallyl phthalate and diallyl adipate, and amides of carboxylic acids such as N,N-diallyl adipamide. Examples of photopolymerization initiators which can be blended with the acrylic compounds include the following specific initiators such as benzil, methyl o-benzoate, benzoin, benzoin ethyl ether, benzoin isopropyl ether, benzoin isobutyl ether, benzophenone/tertiary amine, acetophenones such as 2,2-diethoxyacetophenone, benzil methyl ketal, 1-hydroxycyclohexyl phenyl ketone, 2-hydroxy-2-methyl-1-phenylpropan-1-one, 1-(4-isopropylphenyl)-2-hydroxy-2-methylpropan-1-one, 2-benzyl-2-N,N-dimethylamino-1-(4-morpholinophenyl)-1-butanone, 2,4,6-trimethylbenzoyldiphenyl-phosphine oxide, and 2-methyl-1-4-(methylthio)phenyl-2-morpholino-1-propanone. These compounds may be used individually or in combination.

Cationically polymerizable materials include but are not limited to materials containing epoxy and vinyl ethers functional groups. These series are photoinitiated by onium salt initiators such as triarylsulfonium and diaryliodonium salts.

Polymers desirable for the light-transmissive body 21 include polycarbonate, polymethylmethacrylate, polyethyleneterephthalate, and crosslinked acrylates such as multi-functional acrylates or epoxies, and acrylated urethanes blended with mono- and multi-functional monomers. These polymers are useful in terms of one or more of thermal stability, environmental stability, clarity, separation from forming tool or mold tool, and acceptability for the optical function layer.

(Optical Function Layer)

The optical function layer 22 is formed on the structured surface 21a of the light-transmissive body 21. The optical function layer 22 includes an optical multilayer film configured to reflect light of a specific wavelength band (first wavelength band), and configured to have passed therethrough light of a wavelength band other than the above specific wavelength band (second wavelength band). In this embodiment, the light of the specific wavelength band is an infrared light range including near-infrared light, while light other than the light of the specific wavelength band is a visible light range.

The optical function layer 22 is formed of, for example, a laminated film provided with alternating layers of a first refractive index layer (low refractive index layer), and a second refractive index layer (high refractive index layer) larger than the first refractive index layer in refractive index. Alternatively, the optical function layer 22 is formed of a laminated film provided with alternating layers of a metal layer having high reflectance in the infrared light range, and an optically-transparent layer having a high refractive index in the visible light range and functioning as an anti-reflective layer, or a transparent conductive film.

The metal layer having high reflectance in the infrared light range is composed mostly of a single element such as Au, Ag, Cu, Al, Ni, Cr, Ti, Pd, Co, Si, Ta, W, Mo, and Ge, or an alloy made mostly of two or more of those elements. More specifically, an alloy such as AlCu, AlTi, AlCr, AlCo, AlNdCu, AlMgCu, AgPdCu, AgPdTi, AgCuTi, AgPdCa, AgPdMg, and AgPdFe may be used as material of the metal layer. The above optically-transparent layer is made mostly of high-permittivity material such as niobium oxide, tantalum oxide, or titanium oxide. The transparent conductive film is made mostly of, for example, zinc oxide, indium-doped tin oxide, or the like.

The optical function layer 22 is not limited to a thin multilayer film made of inorganic material. For example, the optical function layer 22 may be composed of a thin film made of high-polymer material, or a laminated film of layers made of high-polymer material having scattered fine particles or the like. The optical function layer 22 is not limited in thickness to a specific value, but necessary to reflect light in a specific wavelength band with a specific efficiency in reflectance. For example, dry process such as a CVD (chemical vapor deposition) method, sputtering method and vacuum vapor deposition method, or wet process such as dip coating method and die coating method can be used as a method of forming an optical function layer 22. The optical function layer 22 is formed on the structured surface 21a of the light-transmissive body 21, and substantially uniform in thickness. In this case, for the purpose of enhancing adhesion of the optical function layer 22 to the light-transmissive body 21, the structured surface 21a may be treated, or an adhesion layer such as resin film may be formed on the structured surface 21a.

[Intermediate Layer]

The structured layer 20 is bonded to the first and second transmissive base members 11 and 12 through intermediate layers 31 and 32 on the basis of, for example, a thermal compression bonding method. The intermediate layers 31 and 32 are formed of transmissive thermoplastic resin, soften at the time of thermal compression bonding, and adhere tightly to the structured layer 20. More specifically, the intermediate layer 31 is constructed as a transmissive adhesion layer which is configured to have the rear surface 21b of the structured layer 20 adhere to the first transmissive base member 11. The intermediate layer 32 is constructed as a transmissive adhesion layer which is configured to have the structured surface 21a of the structured layer 20 adhere to the second transmissive base member 12.

The intermediate layers 31 and 32 are made of resin material which is lower in softening temperature than that of the light-transmissive body 21 of the structured layer 20. Therefore, it is possible to prevent the thermal deformation of the structured surface 21a of the light-transmissive body 21 at the time of thermal compression bonding. The temperature required for thermal compression bonding is not specifically limited, but in this embodiment, the temperature required for thermal compression bonding is within a range from 130 degrees Celsius to 140 degrees Celsius. Therefore, resin material with softening temperature equal to or lower than 130 degrees Celsius is used for the intermediate layers 31 and 32. Copolymer including ethylene vinyl acetate (EVA), polyvinyl alcohol (PVA), polyvinyl butyral (PVB), or the like may be used as main material of the intermediate layers 31 and 32.

On the other hand, the light-transmissive body 21 is formed of resin material which does not soften at the relevant softening temperature. It is preferable that the light-transmissive body 21 be formed of resin material which softens at temperature equal to or larger than 140 degrees Celsius. As another preferable value, it is preferable that the softening temperature of the light-transmissive body 21 be equal to or larger than 150 degrees Celsius. As further preferable value, it is preferable that the softening temperature of the light-transmissive body 21 be equal to or larger than 170 degrees Celsius. Further, the light-transmissive body 21 has loss elastic modulus equal to or larger than 1.0×10⁻⁶ Pa at a temperature of 140 degrees Celsius and a frequency of 1 Hz. When the light-transmissive body 21 has storage elastic modulus smaller than 1.0×10⁻⁶ Pa, there is a risk of deforming the structured surface 21a at the time of thermal compression bonding to reduce recursive reflection.

Each of the intermediate layers 31 and 32 has melt viscosity equal to or larger than 10000 Pa·s at 110 degrees Celsius, and equal to or smaller than 100000 Pa·s at 140 degrees Celsius. When the melt viscosity of the intermediate layers 31 and 32 is smaller than, for example, 10000 Pa·s at 110 degrees Celsius, the structured layer 20 is misaligned with respect to the transmissive base members 11 and 12 at the time of thermal compression bonding in some cases. When the intermediate layers 31 and 32 are too reduced in strength, the optical laminated product 1 is reduced in resistance to penetrability in some cases. On the other hand, when the melt viscosity of the intermediate layers 31 and 32 is larger than, for example, 100000 Pa·s at a temperature of 140 degrees Celsius, it is difficult to stably form the intermediate layers 31 and 32 in some cases. Further, because of embrittlement of the extremely-hardened intermediate layers 31 and 32, the optical laminated product 1 is reduced in resistance to penetrability in some cases.

The structured surface 21a of the structured layer 20 covered with the optical function layer 22 is embedded in the intermediate layer 32 formed between the structured layer 20 and the second transmissive base member 12. Therefore, to ensure a sharpness of an image passed through the optical laminated product 1, it is preferable that the intermediate layer 32 be the same as the light-transmissive body 21 in refractive index. The difference in refractive index between the light-transmissive body 21 and the intermediate layer 32 is equal to or smaller than for example 0.03. As a preferable value, the difference in refractive index between the light-transmissive body 21 and the intermediate layer 32 is equal to or smaller than 0.01. Further, in order to prevent the optical function layer 22 from corrosion, it is preferable to reduce an amount of water contained in intermediate layer 32. For example, it is preferable that an amount of water in the intermediate layer 32 be equal to or smaller than 1 weight percent. In order to prevent the decline in adhesion of the optical function layer 22 and the intermediate layer 32 extremely reduced in contained amount of water, tackifier may be added to the intermediate layer 32.

[Operation of Optical Laminated Product]

FIG. 5 is a schematic view for explaining one operation of the optical laminated product 1. In the optical laminated product 1, the first light-transmissive body 11 is located inside a building (vehicle), while the second light-transmissive body 12 is located outside the building (vehicle). For example, sunlight enters the optical laminated product 1. In the optical laminated product 1, regarding sunlight passed through the second transmissive base member 12, light L1 in an infrared band is reflected by the optical function layer 22, while light L2 in a visible band is passed through the optical function layer 22 and outputted through the first transmissive base member 11. Therefore, the optical laminated product 1 ensures visibility in that the user can look out of the window of a building (vehicle) through the optical laminated product 1, while suppressing the rise in surrounding temperature in a building or in a vehicle.

In the optical laminated product 1 of this embodiment, the optical function layer 22 has directionality to perform recursive reflection in an incident direction of infrared light L1 (heat ray), because the optical function layer 22 is formed on the structured surface 21a having a recursive reflection structure. Therefore, the optical laminated product 1 can suppress the rise in surrounding temperature in a building or in a vehicle in comparison with the regular reflection of incident light by the optical function layer.

Further, in the optical laminated product 1 of this embodiment, the intermediate layer 32 formed between the first and second transmissive base members 11 and 12 functions as a protection layer to seal the structured surface 21a and the optical function layer 22. Therefore, the structured surface 21a and the optical function layer 22 are protected from damage or contamination. It is possible to enhance the quality in durability and weather resistance of the structured layer 20.

Further, according to this embodiment, the optical laminated product 1 can be integrally attached to the window material of a building or a vehicle, because of the laminated structure of the structured layer 20 and two transmissive base members 11 and 12.

[Method of Producing Optical Laminated Product]

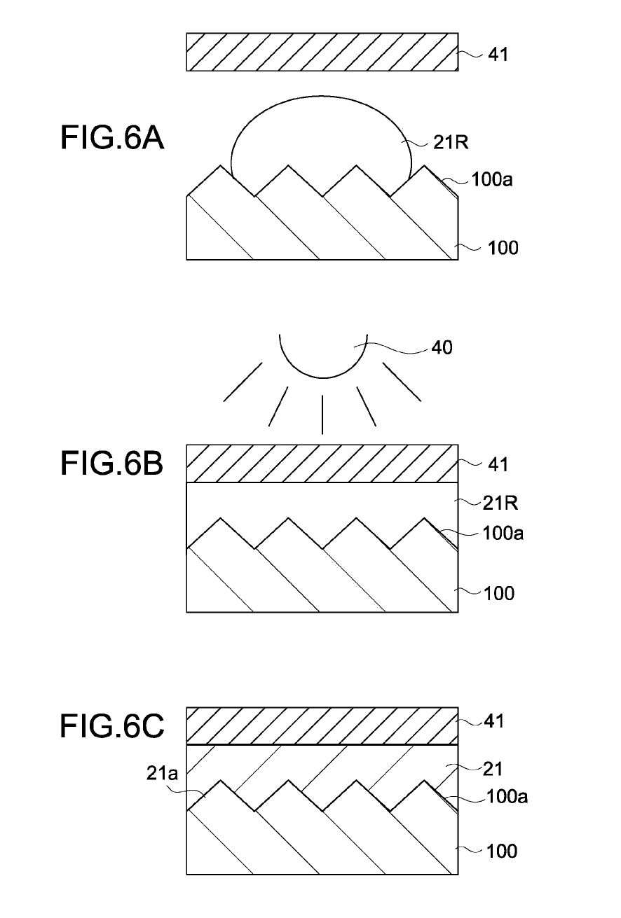

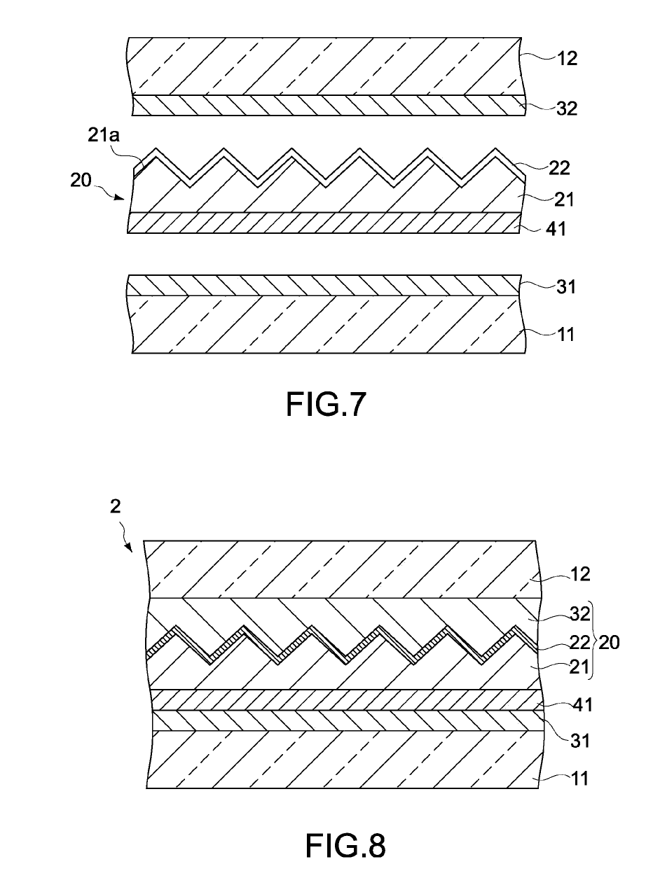

Then, a method of producing the optical laminated product 1 in this embodiment will be described. FIGS. 6 and 7 are schematic process charts for explaining a method of producing the optical laminated product 1.

As shown in FIGS. 6A to 6C, the light-transmissive body 21 having a structured surface 21a is firstly formed. As an example of a method of forming the light-transmissive body 21, a mold tool 100 formed with a convexo-concave shaped transcription surface 100a corresponding to the structured surface 21a is produced. A specific amount of ultraviolet curable resin 12R is applied to the transcription surface 100a (FIG. 6A). Then, in order to planarize the upper surface of the ultraviolet curable resin 12R, the base member 41 made of transparent resin film having ultraviolet-transmitting properties is placed on the transcription surface 100a (FIG. 6B). The base member 41 is made of resin such as polyethylene terephthalate (PET) and polyethylene naphthalate (PEN), each of which has a predetermined thickness. Then, when the ultraviolet curable resin 12R is subjected to and cured by ultraviolet light from an ultraviolet (UV) light source 40 through the base member 41, the light-transmissive body 21 provided with a structured surface 21a corresponding to the shape of the transcription surface 100a is formed (FIG. 6C). Then, the structured layer 20 is produced through steps of separating the light-transmissive body 21 from the mold tool 100, and forming the optical function layer 22 on the structured layer 21a.

Then, as shown in FIG. 7, the first transmissive base member 11 on which the intermediate layer 31 is formed and the second transmissive base member 12 on which the intermediate layer 32 is formed are prepared. Specifically, a method of forming the intermediate layers 31 and 32 is not limited, and various application techniques or adhesion techniques may be selectively used. Then, the intermediate layers 31 and 32 are placed inside the first and second transmissive base members 11 and 12, the structured layer 20 is sandwiched between the first and second transmissive base members 11 and 12, and the thermal compression bonding is performed. The optical laminated product 2 shown in FIG. 8 is produced through this process.

The optical laminated product 2 is different from the optical laminated product 1 shown in FIG. 1 in that the base member 41 intervenes between the light-transmissive body 21 and the intermediate layer 31. Therefore, the optical laminated product 1 shown in FIG. 1 is produced through steps of stacking the transmissive base members 11 and 12 under the condition that the base member 41 is separated, after producing the structured layer 20. According to the optical laminated body 2 shown in FIG. 2, it is easy to perform production and handling operation of the light-transmissive body 21, because the base member 41 can support the light-transmissive body 21. Therefore, it is possible to stably perform the lamination of the light-transmissive body 21 to the transmissive base members 11 and 12. Further, it is possible to improve productivity by using the base member 41 to perform continuous production of the structured layer 20 by a roll method.

As the thermal compression bonding technique for adhesion of the structured layer 20 to the transmissive base members 11 and 12, hot press (HP) and hot isostatic press (HIP), or the like is used. It is possible to arbitrarily set the condition of the thermal compression bonding. For example, the pressure for the thermal compression bonding is in the range of 1 MPa to 1.5 MPa at the temperature of 130 to 140 degrees Celsius. Furthermore, it is possible to effectively remove water from the intermediate layers 31 and 32 by performing the above thermal compression bonding process in a vacuum. Furthermore, it is possible to accelerate degassing of the intermediate layers 31 and 32 by performing preliminary heating in a reduced-pressure atmosphere of several kPa.

### Second Embodiment

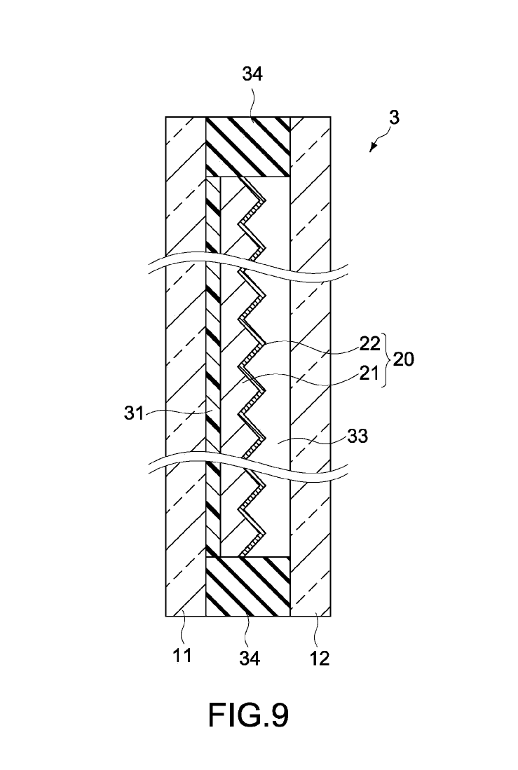

FIG. 9 is a schematic cross-sectional view of a main section of an optical laminated product according to the second embodiment. In FIG. 9, some sections of the optical laminated product according to the second embodiment will not be described in detail as being the same in reference symbol as corresponding sections of the optical laminated product according to the first embodiment.

In this embodiment, an optical laminated product 3 has a first transmissive base member 11, a second transmissive base member 12, and a structured layer 20 arranged between the first transmissive base member 11 and the second transmissive base member 12. An intermediate layer 31 is formed between the structured layer 20 and the first transmissive base member 11. A gas layer 33 is formed between the structured layer 20 and the second transmissive base member 12. Further, a sealing member 34 for sealing in the gas layer 33 is arranged between the first transmissive base member 11 and the second transmissive base member 12.

The gas layer 33 is formed of rare gas or inactive gas. Hereinafter, rare gas and inactive gas are collectively called “inactive gas”. For example, argon, nitrogen, or the like is used as inactive gas forming the gas layer 33. The inactive gas of the gas layer 33 is not limited in pressure, and, for example, may be positive in pressure. Therefore, it is possible to protect the optical function layer 22 from corrosion or deterioration resulting from water vapor by preventing invasion of outer air into the gas layer 33, and to prevent the transmissive base member 12 from being damaged by environmental pressure.

The sealing member 34 is formed in a circular pattern (in the shape of frame) along the transmissive base members 11 and 12. The sealing member 34 is formed of elastic material such as rubber and elastomer, or adhesive material. The transmissive base members 11 and 12 are integrally joined with the sealing member 34, and an airtight space is formed between the transmissive base members 11 and 12. The gas layer 33 is formed through steps of filling this airtight space with inactive gas. It is easy to form the gas layer 33 by forming layers of the transmissive base members 11 and 12 in inactive gas. Or, it is possible to form the gas layer 33, by reason that, after forming layers of the transmissive base members 11 and 12, and exhausting air of the airtight space through an outlet formed in the sealing member 34, the inactive gas is introduced into the airtight space through the outlet. The outlet is sealed after filling the airtight space with the inactive gas.

The optical laminated product 3 thus constructed in the this embodiment can attain advantageous effect the same as that of the first embodiment. Additionally, in place of the above configuration in which the first transmissive base member 11 and the structured layer 20 are joined with the intermediate layer 31, it is possible to form a layer of inactive gas between those layers.

### Third Embodiment

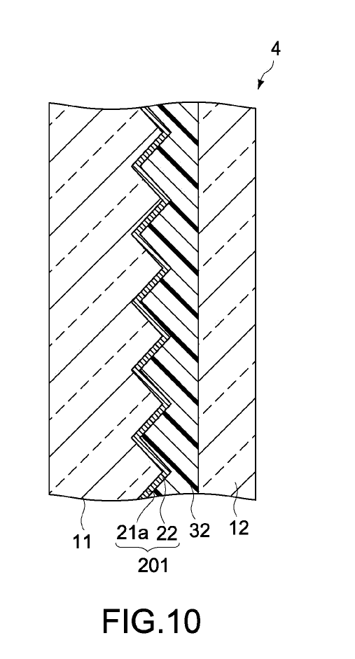

FIG. 10 is a schematic cross-sectional view of a main section of an optical laminated product according to the third embodiment. In FIG. 10, some sections of the optical laminated product according to the third embodiment will not be described in detail as being the same in reference symbol as corresponding sections of the optical laminated product according to the first embodiment.

An optical laminated product 4 of the present embodiment differs from that of the first embodiment in that the first transmissive base member 11 has a structured surface 21a which is defined on an inner surface of the first transmissive base member 11, and on which recursive reflective concave sections are one or two-dimensionally arranged. In this embodiment, the optical function layer 22 is formed on the structured surface 21a. More specifically, in this embodiment, the optical laminated product 4 has a structured layer 201 composed of the structured surface 21a and the optical function layer 22.

The optical laminated product 4 of the present embodiment has advantageous effects the same as those of the first embodiment. Specifically, the optical laminated product 4 can be reduced in thickness, by reason that the optical laminated product 4 does not need the light-transmissive body 21 of the first embodiment.

### Fourth Embodiment

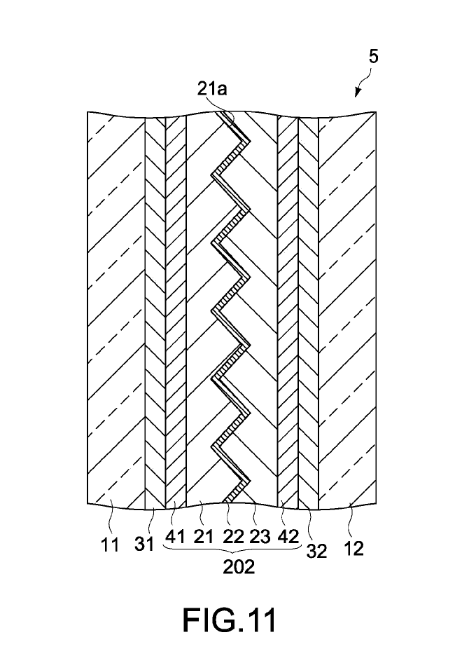

FIG. 11 is a schematic cross-sectional view of a main section of an optical laminated product according to the fourth embodiment. In FIG. 11, some sections of the optical laminated product according to the fourth embodiment will not be described in detail as being the same in assigned reference symbol as corresponding sections of the optical laminated product according to the first embodiment.

A structured layer of an optical laminated product 5 according to the fourth embodiment is different in configuration from that of the optical laminated product according to the first embodiment. In this embodiment, the structured layer 202 has a first light-transmissive body 21 having a structured surface 21a provided with a recursive reflection property, an optical function layer 22 formed on the structured surface 21a, and a second light-transmissive body 23 with which the structured surface 21a and the optical function layer 22 are covered. The second light-transmissive body 23 is formed of ultraviolet curable resin as in the case of the first light-transmissive body 21, and configured to function as a protection layer to have the optical function layer 22 embedded therein.

The structured layer 202 further has a first base member 41 and a second base member 42. The first and second base members 41 and 42 are made of transparent plastic film such as polyethylene terephthalate (PET) and polyethylene naphthalate (PEN). These base members 41 and 42 are configured to function as a supporting layer for supporting the light-transmissive bodies 21 and 23 when those are formed from ultraviolet curable resin, and provided in continuous production of the structured layer 202 by roll-to-roll production system. The base members 41 and 42 may be separated from the light-transmissive bodies 21 and 23 after the light-transmissive bodies 21 and 23 are formed. Or, as shown in FIG. 11, the base members 41 and 42 may be stacked on the transmissive base members 11 and 12 with the light-transmissive bodies 21 and 23, without being separated from the light-transmissive bodies 21 and 23.

The optical laminated product 5 thus constructed in this embodiment can attain advantageous effect the same as that of the first embodiment. Specifically, the difference in refractive index between the light-transmissive bodies 21 and 23 becomes substantially equal to zero, because the light-transmissive bodies 21 and 23 are made of respective resins the same in type of resin as each other. Therefore, the optical laminated product 5 can reduce deterioration in sharpness of image passed through the optical laminated product 5.

### Fifth Embodiment

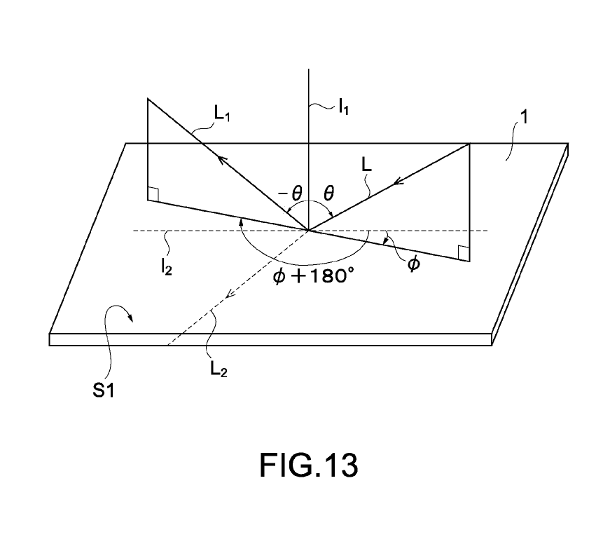

In this embodiment, the following description is directed to an optical laminated product 1 configured to function as a directional reflector. FIG. 13 is a perspective view showing the relationship between incident light entering the optical laminated product 1 and light reflected by the optical laminated product 1. The optical laminated product 1 has an incident surface S1 which is flat, and which light enters. The optical laminated product 1 is configured to selectively reflect light L₁ of a specific wavelength band in a direction other than a regular reflection direction (−θ, φ+180 degrees), and configured to have passed therethrough light L₂ other than light of the specific wavelength band, as part of light L entering the incident surface S1 at an incident angle (θ, φ). The optical laminated product 1 has transparency in light other than light of the specific wavelength band. As this transparency, it is preferable to have a range of sharpness of transmission image, which will be described later. Here, the character “θ” is indicative of an angle between a line l₁ vertical to the incident surface S1 and the incident light L entering the incident surface S1 or light L₁ reflected from the incident surface. The character “φ” is indicative of an angle between a specific line l₂ on the incident surface S1 and a projected component of the incident light L or the reflected light L₁ to the incident surface S1. Here, the specific line l₂ on the incident surface corresponds to an axis in which, when an incident angle (θ, φ) is fixed and the optical laminated product 1 is rotated with respect to the line l₁ vertical to the incident surface S1 of the optical laminated product 1, light reflected at an angle “φ” has maximum intensity. If there are two or more axes (directions) of maximum intensity, one of the axes is selected as a line l₂. Additionally, an angle “θ” of clockwise rotation with respect to line l₁ vertical to the incident surface is shown by “+θ”, while an angle “θ” of counterclockwise rotation with respect to line l₁ vertical to the incident surface is shown by “−θ”. An angle “φ” of clockwise rotation with respect to the line l₂ is shown by “−φ”, while an angle “φ” of counterclockwise rotation with respect to the line l₂ is shown by “−φ”.

Here, light of a specific wavelength band to be reflected in a specific direction and light to be passed through the optical laminated product 1 vary depending on the intended use of the optical laminated product 1. For example, when the optical laminated product 1 is applied to a window material, it is preferable that light of a specific wavelength band to be reflected in a specific direction may be near-infrared light, and the light of a specific wavelength to be passed through the optical laminated product 1 may be visible light. More specifically, it is preferable that light of a specific wavelength band to be reflected in a specific direction may be mainly near-infrared light in the 780 nm to 2100 nm range. The optical laminated product 1 can suppress the rise of room temperature resulting from light energy passing through the window from the sun under the condition that the optical laminated product configured to reflect near-infrared light is attached to the window glass. Therefore, the optical laminated product 1 can reduce load of air conditioner and achieve energy savings. Here, the “directional reflection” refers to reflection in a specific direction other than the direction of a regular reflection (in which incident angle and reflection angle are the same as each other, and to reflection with intensity and larger than that in the regularly-reflected light, and sufficiently larger than that in the non-directional reflection. Here, regarding reflection of light, it is preferable that reflectance in a specific wavelength band, for example, the range of near-infrared light be equal to or larger than 30%. As another preferable value, reflectance is equal to or larger than 50%. As further preferable value, reflectance is equal to or larger than 80%. Regarding transmission of light, it is preferable that transmittance in a specific wavelength band, for example, the range of visible light be equal to or larger than 30%. As another preferable value, transmittance is equal to or larger than 50%. As further preferable value, transmittance is equal to or larger than 70%.

It is preferable that the direction φ₀ of directional reflection be equal to or larger than −90 degrees, and equal to or smaller than 90 degrees. This is because, when the optical laminated product 1 is applied and used as a window material, light of a specific wavelength band forming part of light from the sky can be reflected to the sky. When there is no high-rise building in the neighborhood, the optical laminated product 1 configured to reflect specific light in this direction is available. Further, it is preferable that the direction of directional reflection be close to an angle of (θ, −φ). Here, regarding neighborhood of an angle of (θ, −φ), it is preferable that deviation from an angle (θ, φ) be equal to or smaller than 5 degrees. As another preferable value, deviation from an angle (θ, φ) may be equal to or smaller than 3 degrees. As further preferable value, deviation from an angle (θ, φ) may be equal to or smaller than 2 degrees. In this range, when the optical laminated product 1 is attached to the window material, the optical laminated product 1 can effectively reflect light of the specific wavelength band to the sky over other buildings standing side by side, which forms part of light from the sky over buildings, similar in height, standing side by side. It is preferable to use, for example, part of spherical surface or hyperboloid, three-sided pyramid, four-sided pyramid, circular cone, or other three dimensional structure. When light entering at an angle of (θ, φ) (−90 degrees<φ<90 degrees), light can be reflected at an angle of (θ₀, φ₀) (0 degrees<θ₀<90 degrees, −90 degrees<φ₀<90 degrees), or it is preferable to use cylinder extending in one direction. When light entering at an angle of (θ, φ) (−90 degrees<φ<90 degrees), light can be reflected at an angle of (θ₀, −φ) (0 degrees<θ₀<90 degrees).

It is preferable that a directional reflection of light of a specific wavelength to light entering the incident surface S1 at an incident angle (θ, φ) be close to a recursive reflection neighborhood direction or an angle (θ, φ). When the optical laminated product 1 is applied as a window material, the optical laminated product 1 can reflect light of a specific wavelength to the sky, as part of light from the sky. Here, it is preferable that deviation from an angle (θ, φ) be equal to or smaller than 5 degrees. As another preferable value, deviation from an angle (θ, φ) may be equal to or smaller than 3 degrees. As further preferable value, deviation from an angle (θ, φ) may be equal to or smaller than 2 degrees. In a range defined above, the optical laminated product 1 can effectively reflect light in a specific wavelength band to the sky, as part of light from the sky. When, for example, an infrared light transmitter and receiver are closely arranged as in an infrared light sensor, an infrared image device, and the like, it is necessary that the recursive reflection neighborhood direction is the same as direction of incident light. In the present invention, when it is not necessary to sense light in a specific direction, it is not necessary that the recursive reflection neighborhood direction is the same as direction of incident light.

It is preferable that sharpness of transmissive image of an optical comb of 0.5 mm, measured from light passed in a wavelength band through the optical laminated product, be equal to or larger than 50. As another preferable value, the sharpness of transmissive image of an optical comb of 0.5 mm be equal to or larger than 60. As further preferable value, the sharpness of transmissive image of an optical comb of 0.5 mm be equal to or larger than 75. On the other hand, when the sharpness of transmissive image of an optical comb of 0.5 mm is smaller than 50, the transmissive image tends to be defocused. When the sharpness of transmissive image of an optical comb of 0.5 mm is equal to or larger than 50 and smaller than 60, there is no problem with one's daily life even though the sharpness depends on external brightness. When the sharpness of transmissive image of an optical comb of 0.5 mm is equal to or larger than 60 and smaller than 75, the user may be conscious of a diffraction pattern produced in response to an extremely bright object such as light source, but can look out the window in focus. When the sharpness of transmissive image of an optical comb of 0.5 mm is equal to or larger than 75, the user is hardly conscious of the diffraction pattern. Further, it is preferable that the sum of the measured sharpness of transmissive image of optical combs of 0.125 mm, 0.5 mm, 1.0 mm, and 2.0 mm be equal to or larger than 230. As another preferable value, the sum may be equal to or larger than 270. As another preferable value, the sum may be equal to or larger than 350. When the sum is smaller than 230, the transmissive image tends to be defocused. When, on the other hand, the sum is equal to or larger than 230 and smaller than 270, there is no problem with one's daily life even though the sharpness depends on external brightness. When the sum is equal to or larger than 270 and smaller than 350, the user may be conscious of a diffraction pattern produced in response to an extremely bright object such as light source, but can look out the window in focus. When the sum is equal to or larger than 350, the user is hardly conscious of the diffraction pattern. Here, the sharpness of transmissive image of an optical comb is measured on the basis of the Japanese Industrial Standards K-7105 by ICM-IT (produced by Suga Test Instruments Co., Ltd.). When light to be passed through the optical laminated product differs in wavelength from the light source D65, it is preferable that the sharpness be measured after being corrected by a filter corresponding to light to be passed through the optical laminated product.

It is preferable that a haze value be equal to or smaller than 6% in the wavelength range having transparency. As another preferable range, a haze value may be equal to or smaller than 4%. As further preferable range, a haze value may be equal to or smaller than 2%. When a haze value is larger than 6%, the user feels that the sky seems to be cloudy, resulting from the fact that the transmitted light is scattered. Here, a haze value is measured by HM-150 (produced by MURAKAMI COLOR RESEARCH LABORATORY CO., Ltd.) on the basis of the measuring method defined by the Japanese Industrial Standards K-7136. When light to be passed through the optical laminated product differs in wavelength from the light source D65, it is preferable that a haze value be measured after being corrected by a filter corresponding to light to be passed through the optical laminated product. Further, the entrance place S1 of the optical laminated product 1, or preferably both the incident surface S1 and the output surface S2 have flatness necessary to prevent the sharpness of transmissive image of an optical comb from being deteriorated. Specifically, it is preferable that an arithmetic average Ra of roughness of the incident surface S1 and the output surface S2 be equal to or smaller than 0.08 μm. As another preferable value, the arithmetic average Ra of roughness may be equal to or smaller than 0.06 μm. As further preferable value, the arithmetic average Ra of roughness may be equal to or smaller than 0.04 μm. Furthermore, the above arithmetic average Ra of roughness is calculated through steps of measuring roughness of the incident surface, obtaining a roughness curve from a two-dimensional cross-section curve, and calculating a roughness parameter from the roughness curve. Measurement condition is based on the Japanese Industrial Standards B0601: 2001. The measurement instrument and the measurement condition are as follows:

Measurement Device:

Automatic Microfigure Measuring Instrument
SURFCORDER ET4000A (produced by Kosaka Laboratory Ltd.)

Measurement Condition:

λc=0.8 mm

estimation length: 4 mm

cutoff: ×5

data sampling interval: 0.5 μm

It is preferable that light passed through the optical laminated product 1 have almost neutral in color, even though there is such a thing as a colored optical laminated product, light passed through the optical laminated product 1 have sickly pastel color such as blue, blue green, green, and the like impressing the user favorably. In terms of producing favorable color, when, for example, the optical laminated product 1 is exposed to irradiation from the light source D65, it is preferable that trichromatic coordinates (x, y) of light entered through the entrance plane S1, passed through the structured layer 20, and outputted from the output surface S2 be 0.20<x<0.35, and 0.20<y<0.40. As another preferable range, 0.25<x<0.32, and 0.25<y<0.37. As further preferable range, 0.30<x<0.32, and 0.30<y<0.35. In terms of producing favorable color without being slightly reddish in color, it is preferable that y>x−0.02. As another preferable value, y>x. Furthermore, if the change in color of light reflected by an optical laminated product applied to, for example, the window of a building is caused by the incident angle of light, it is preferable not to allow the user to feel that the optical laminated product differs in color with location, or when the user looks at the optical laminated product while walking, the user feels the change in color of the optical laminated product. Therefore, in terms of suppressing the change in color of the optical laminated product, it is preferable that light enter the incident surface S1 or the output surface S2 at an angle “θ” equal to or larger than 5 degrees and equal to or smaller than 60 degrees, the absolute value of the difference of chromatic coordinates “x” and the absolute value of the difference of chromatic coordinates “y” of light regularly reflected by the structured layer 20 be equal to or smaller than 0.05 in each principal surface of the optical laminated product 1, as another preferable value, equal to or smaller than 0.03, as further preferable value, equal to or smaller than 0.01. It is preferable that the limitation of the numerical range about the chromatic coordinates “x” and “y” of this reflected light be satisfied in each of the incident surface S1 and the output surface S2.

### PRACTICAL EXAMPLES

Hereinafter, practical examples will be described. However, the present invention is not limited to the following examples.

Samples of the optical laminated products different from each other in type of ultraviolet curable resin and laminated structure of the light transmissive body 21 ware produced, and then tested in temporal change of transmittance.

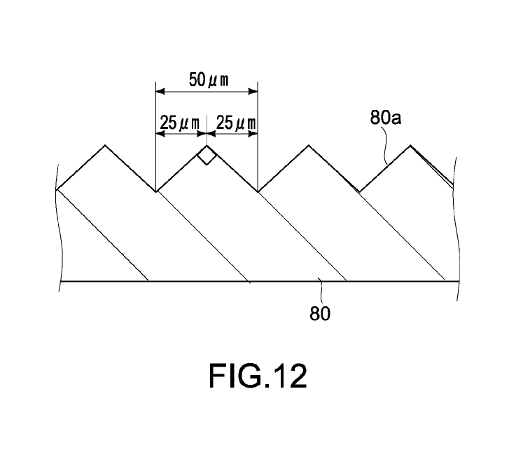

Prior to producing samples of the optical laminated products, a mold tool 80 shown in FIG. 12 was produced of Ni—P, and has a structured surface 80a formed with concave sections arranged successively. Each of the CCP (corner cube prism) prism-shaped concave sections is an isosceles triangle in cross-section, 100 μm in width (array pitch) of the prism-shaped concave sections, and 47 μm in depth. Further, samples of the optical laminated products were produced of the following four groups of ultraviolet curable resins “A”, “B”, “C”, and “D” in the following fundamental composition.

<Fundamental Composition of the Resin “A”>

Urethane Acrylate (“ARONIX” produced by Toagosei Co., Ltd. (Registered Trademark of Toagosei Co., Ltd.)): 97 weight percent

Photopolymerization Initiator (“IRGACURE 184” produced by Nippon Kayaku Co., Ltd. (Registered Trademark of Ciba Holding Inc., Switzerland)): 3 weight percent

Loss elastic modulus at a temperature of 140 degrees Celsius: 1.3×10⁵ Pa

Refractive index: 1.533

<Fundamental Composition of Resin “B”>

Urethane Acrylate (“ARONIX” produced by Toagosei Co., Ltd. (the same as above)): 82 weight percent

Cross-linking Agent (“T2325” produced by Tokyo Chemical Industry Co., Ltd.): 15 weight percent

Photopolymerization Initiator (“IRGACURE 184” produced by Nippon Kayaku Co., Ltd. (the same as above)): 3 weight percent

Loss elastic modulus at a temperature of 140 degrees Celsius: 1.0×10⁶ Pa

Refractive index: 1.529

<Fundamental Composition of Resin “C”>

Urethane Acrylate (“ARONIX” produced by Toagosei Co., Ltd. (the same as above)): 67 weight percent

Cross-linking Agent (“T2325” produced by Tokyo Chemical Industry Co., Ltd.): 30 weight percent

Photopolymerization Initiator (“IRGACURE 184” produced by Nippon Kayaku Co., Ltd. (the same as above)): 3 weight percent

Loss elastic modulus at a temperature of 140 degrees Celsius: 2.1×10⁶ Pa

Refractive index: 1.529

<Fundamental Composition of Resin “D”>

Urethane Acrylate (“UF-8001G” produced by Kyoeisha Chemical Co., Ltd.): 30 weight percent

Triethylene Glycol Diacrylate (“LIGHT-ACRYLATE 3EG-A” produced by Kyoeisha Chemical Co., Ltd.): 30 weight percent

Benzyl Methacrylate (“LIGHT-ESTER BZ” produced by Kyoeisha Chemical Co., Ltd.): 7 weight percent

Cross-linking Agent (“T2325” produced by Tokyo Chemical Industry Co., Ltd.): 30 weight percent

Photopolymerization Initiator (“IRGACURE 184” produced by Nippon Kayaku Co., Ltd. (the same as above)): 3 weight percent

Loss elastic modulus at a temperature of 140 degrees Celsius: 1.1×10⁶ Pa

Refractive index: 1.486

The loss elastic modulus of the above resins “A”, “B”, “C”, and “D” measured as follows.

Each of the cured resins “A”, “B”, “C”, and “D”, which is 100 μm in thickness, was cut with a width of 20 mm and a length of 40 mm. When the temperature of each resin was increased from −50 degrees Celsius to 150 degrees Celsius at the rate of 5 degrees/minute, the dynamic viscoelasticity at 1 Hz of each resin was measured by a dynamic viscoelasticity measuring device “DVA-220” produced by IT Keisoku Seigyo Co., Ltd.

### Example 1

The resin “B” was applied to the structured surface 80a of the mold tool 80, and then a 75 micrometer-thick film of polyethylene terephthalate (hereinafter simply referred to as “PET film”) (“A4300” produced by Toyobo Co., Ltd.) was formed on it. Then, after the resin “B” was subjected to, and cured by ultraviolet light through the PET film, a layered product of the resin “B” and the PET film was separated from the mold tool 80. In this way, a resin layer (light-transmissive body 21) having a structured surface formed with arranged prism-shaped concave sections (FIG. 2) was produced.

Then, a laminated film provided with alternating layers a diniobium pentoxide film and a silver film was formed on the obtained prism-shaped structured surface of the layered product as the optical function layer by a sputtering method.

Then, after the resin “B” was applied to the optical function layer, a PET film (“A4300” produced by Toyobo Co., Ltd.) was formed on it. A second light-transmissive body 21 (FIG. 11) was produced through steps of having this layer of the resin “B” subjected to, and cured by ultraviolet light. In this way, the structured layer (FIG. 11) which is a desired directional reflector was produced.

Then, to polyvinyl butyral resin (produced by Sigma-Aldrich Corporation) of 100 wt. pts. (parts by weight), triethylene glycol diethylene butyrate (3GO, produced by Sigma-Aldrich Corporation) of 40 wt. pts., and acetic acid aqueous solution of magnesium (density: 15 weight percent, produced by Sigma-Aldrich Corporation) of 0.3 wt. pts. were added, then mixed by a kneading machine, then extruded into a sheet by an extruding machine, and then two 320 μm-thick intermediated film for the laminated glass were produced. Then, two produced intermediated films were respectively stacked on two floated glasses (100 mm in length, 100 mm in width, and 2.5 mm in thickness). Then, the structured layer 202 was sandwiched between those float glasses, and then set in an elastic pack. The pressure of air in the elastic pack was reduced to 2.6 kPa, and the laminated product was degassed at a pressure of 2.6 kPa for 20 minutes, and then the degassed laminated product was transferred in unchanged form to an oven, and maintained at a temperature of 100 degrees Celsius for 30 minutes and vacuum press of the laminated product was performed. In this way, the preliminary-compressed laminated product was compressed in an autoclave at a temperature of 135 degrees Celsius at a pressure of 1.2 MPa for 20 minutes. The optical laminated product sample shown in FIG. 11 was produced through the above process.

Then, transmittance of this optical laminated product sample was measured in the range of visible light (wavelength: 550 nm). Then, after a heat cycle test on this optical laminated product sample was carried out, transmittance of this sample was measured again in the range of visible light (wavelength: 550 nm), and the change in transmittance of this sample was evaluated. For this transmittance measurement, a spectrophotometer “V-7100” produced by JASCO Corporation was used. For this heat cycle test, an environment tester “TSA-301L-W” produced by ESPEC Corp. was used. As test condition, a sequence including a step in which this sample is maintained at a temperature of −40 degrees Celsius for one hour, and a step in which this sample is maintained at a temperature of 85 degrees Celsius for one hour was repeated 300 times. The sample was taken out from the environment tester at room temperature after the sequence. In a case that the structured layer was damaged in this sequence, transmittance of the structured layer is changed. This sample was evaluated in durability by an indirect evaluation method based on the change in transmittance of this sample.

### Example 2

An optical laminated product sample was produced under condition the same as that of the example 1 with the exception that, in place of the resin “B”, the optical laminated product sample was produced from the resin “C”. The change in transmittance of this sample was measured before and after the above heat cycle test, and then this sample was evaluated on the basis of the change in transmittance.

### Example 3

In place of the resin “B”, a structured layer was produced from the resin “A” under condition the same as that of the example 1. After this structured layer was sandwiched between two float glasses (100 mm in height, 100 mm in width, and 2.5 mm in thickness) through respective spacers, air between the float glasses was replaced by argon gas, and ends of the float glasses were sealed. The change in transmittance of an optical laminated product sample produced through this process was measured before and after the above heat cycle test, and then this sample was evaluated on the basis of the change in transmittance.

### Example 4

An optical laminated product sample was produced under condition the same as that of the example 1 with the exception that, in place of a laminated film of a layer made of diniobium pentoxide and a layer made of silver as an optical function layer, a semi-transmissive film was made of aluminum on the basis of evaporation method. The change in transmittance of an optical laminated product sample produced through this process was measured before and after the above heat cycle test, and then this sample was evaluated on the basis of the change in transmittance.

### Example 5

The resin “D” was applied to the structured surface 80a of the mold tool 80, and then a 75 micrometer-thick film of polyethylene terephthalate (hereinafter simply referred to as “PET film”) (“A4300” produced by Toyobo Co., Ltd.) was formed on it. Then, after the resin “D” was subjected to, and cured by ultraviolet light through the PET film, a layered product of the resin “D” and the PET film was separated from the mold tool 80. In this way, a resin layer (light-transmissive body 21) having a structured surface formed with arranged prism-shaped concave sections (FIG. 2) was produced.

Then, a multilayer film provided with alternating layers of a layer made of diniobium pentoxide and a layer made of silver were formed on the prism-shaped structured surface of the layered product as the optical function layer by a sputtering method. In this way, the structured layer (FIG. 9) which is a desired directional reflector was produced.

An intermediate layer for laminated glass was produced from the resin “D” under condition the same as that of the example 1. This intermediate layer was stacked on one surface of the first float glass (100 mm in height, 100 mm in width, and 2.5 mm in thickness), and then the structured layer was placed on it. Then, the second float glass (100 mm in height, 100 mm in width, and 2.5 mm in thickness) was stacked on the first float grass through a spacer so that the second float glass faces the structured surface of the structured layer. An optical laminated product sample was produced through steps of setting this laminated product in an elastic pack, reducing the pressure of air in the elastic pack to 2.6 kPa, degassing the laminated product for 20 minutes, setting the degassed laminated product in an oven, and performing vacuum press of the degassed laminated product at a temperature of 100 degrees Celsius for 30 minutes, performing compression of the laminated glass preliminary-compressed in this way in an autoclave at a temperature of 135 degrees Celsius under the pressure of 1.2 MPa for 20 minutes. Then, the optical laminated product sample having a structure shown in FIG. 9 was produced through steps of filling the gap between the structured layer and the second float glass with argon gas, and sealing ends of both float glasses. Then, the change in transmittance of the produced optical laminated product sample was measured before and after the heat cycle test, and evaluated.

### Comparative Example 1

In place of the resin “B”, a structured layer was produced from the resin “A” under condition the same as that of the example 1. The produced structured layer was adhered to one surface of a float glass (100 mm in height, 100 mm in width, and 2.5 mm in thickness) through an adhesion layer so as to produce an optical laminated product sample. The change in transmittance of an optical laminated product sample produced in this way was measured before and after the above heat cycle test, and then this sample was evaluated on the basis of the change in transmittance.

### Comparative Example 2

After the structured layer produced in the comparative example 1 was sandwiched between two float glasses (100 mm in height, 100 mm in width, and 2.5 mm in thickness) through spacers, ends of the float glasses were sealed without replacement of the inside air. The change in transmittance of a produced optical laminated product sample was measured before and after the above heat cycle test, and then this sample was evaluated on the basis of the change in transmittance.

### Comparative Example 3

In place of the resin “B”, an optical laminated product sample was produced from the resin “A” under condition the same as that of the example 1. The change in transmittance of the produced sample was measured before and after the above heat cycle test, and then this sample was evaluated on the basis of the change in transmittance.

In each of the practical examples 1 to 5 and the comparative examples 1 to 3, transmittance measured before and after the test, estimation on the basis of the change of transmittance are collectively shown in Table 1. Here, in the estimation, the character “x” indicates that the relevant example is estimated as a failed example in which the change of transmittance is equal to or larger than 2%, and the character “∘” indicates that the relevant example is estimated as a passed example in which the change of transmittance is less than 2%.

[Table 1]

TABLE 1

| | Configuration | Transmittance (%) | | Change of | Evalu- |
|---|---|---|---|---|---|
| | of resin | Before test | After test | transmittance | ation |
| Comparative | A | 53.2 | 49.3 | −3.9 | x |
| example 1 | | | | | |
| Comparative | A | 53.0 | 50.6 | −2.4 | x |
| example 2 | | | | | |
| Comparative | A | 53.1 | 48.3 | −4.8 | x |
| example 3 | | | | | |
| Practical | B | 53.1 | 51.6 | −1.5 | ∘ |
| example 1 | | | | | |
| Practical | C | 53.1 | 51.6 | −1.5 | ∘ |
| example 2 | | | | | |
| Practical | A | 53.0 | 51.1 | −1.9 | ∘ |
| example 3 | | | | | |
| Practical | B | 53.3 | 51.5 | −1.8 | ∘ |
| example 4 | | | | | |
| Practical | D | 53.2 | 51.3 | −1.9 | ∘ |
| example 5 | | | | | |

As will be seen from the table 1, in each sample of the comparative examples 1 to 3, transmittance measured after the heat cycle test drops significantly in comparison with transmittance measured before the heat cycle test. The reasons are as follows. Regarding the comparative example 1, deformation of the structured surface of the structured layer results from heat cycle. Regarding the comparative example 2, deterioration of the optical function layer results from residual water vapor between the glasses. Regarding the comparative example 3, as a result of the fact that loss elastic modulus of the resin “A” forming the structured surface is low, the shape of the structured surface is deteriorated at the time of thermal compression bonding. Therefore, it's believed that this leads to the drop in transmittance of each sample.

On the other hand, in the practical examples 1 to 5, transmittance measured after the heat cycle test does not drop significantly in comparison with transmittance measured before the heat cycle test. Specifically, regarding the practical examples 1 and 2, each loss elastic modulus of the resins “B” and “C” forming the structured surface is equal to or larger than 1.0×10⁻⁶ Pa. Therefore, it is considered that deformation of the structured surface is suppressed at the time of thermal compression bonding. Regarding the practical examples 3 and 5, it is considered that influence of residual water vapor can be avoided by replacement of the inside air with argon gas. Regarding the practical example 4, although the sample was produced from the resin “A” the same as that of the comparative examples 1 to 3, transmittance measured after the heat cycle test does not drop significantly in comparison with transmittance measured before the heat cycle test. It is considered that the drop in transmittance of this sample is suppressed by the semi-transmissive film replaced with the optical function layer.

In the above-mentioned embodiments, the optical function layer 22 is configured to reflect light in the range of infrared light, and to have visible light passed therethrough. However, the optical function layer 22 is not limited to that of the above-mentioned embodiments. For example, a wavelength band of light to be reflected by the optical function layer, and a wavelength band of light to be passed through the optical laminated product may be set in the range of visible light. In this case, it is possible to have the optical laminated product according to the embodiments function as a color filter.

In the above-mentioned embodiments, the optical laminated product according to the embodiments has been described about an example to be used for architectural or vehicular window material. Further, it is possible to apply the present invention to window materials of a variety of optical devices, each of which is configured to have only light of a specific wavelength band passed therethrough selectively.

Hereinafter, modified examples of the above embodiments will be described.

### Modified Example 1

Hereinafter, a specific example in which a semi-transmissive layer having a transparency to ensure visibility needed to look at the far side through it with low scattering will be described. For example, the semi-transmissive layer is composed of single or multiple metal layers.

(1) The reflection layer of AgTi: 8.5 nm (Ag/Ti=98.5/1.5 at %) is formed on the structured layer in the optical laminated product according to the embodiment.

(2) The reflection layer of AgTi: 3.4 nm (Ag/Ti=98.5/1.5 at %) is formed on the structured layer in the optical laminated product according to the embodiment.

(3) The reflection layer of AgNdCu: 14.5 nm (Ag/Nd/Cu=99.0/0.4/0.6 at %) is formed on the structured layer in the optical laminated product according to the embodiment.

Furthermore, as a method of forming a semi-transmissive layer, for example, a sputtering method, an evaporation method, a dip coating method, or a die-coating method may be used.

### Modified Example 2

FIG. 14A is a cross-sectional view showing one example of the configuration of the optical laminated product according to the modified example 2 (this cross-sectional view focuses on the light-transmissive body 21, the optical function layer 22, and the intermediate layer 32). The optical laminated product of the modified example 2 has a plurality of optical function layers 22 inclined with respect to the incident surface of light, which are formed between the light-transmissive body 21 and the intermediate layer 32. The optical function layers 22 are arranged in parallel or substantially parallel to each other. In this example, as shown in FIG. 14A, both the light-transmissive body 21 and the intermediate layer 32 have permeability, the directional reflection of light L1 of a specific wavelength band passed through the intermediate layer 32 is performed by the optical function layer 22, while light L2 of other wavelength band is passed through the optical function layer 22. Here, the incident surface of light may be defined on the side of the light-transmissive body 21.

FIG. 14B is a perspective view showing one example of the configuration of the structures of the optical laminated product according to this modified example. The structures 11a, each of which is a triangular-prism-shaped convex section extending in one direction, are arrayed in another direction, and collectively form concave sections on a surface of the light-transmissive body 21. The structure 11a has a right-angled triangular shape in cross-section perpendicular to the extending direction of the structures 11a. The optical function layer 22 is formed on sharply-angled inclined surfaces of the structures 11a on the basis of vapor-deposition method, sputtering method, and the like.

In this modified example, the optical function layers 22 are arranged in parallel relationship with each other. The number of reflection times in the optical function layer 22 can be reduced in comparison with the corner-of-cube-shaped or prism-shaped structures 11a. Therefore, it is possible to enhance transmittance, and reduce the absorption of light in the optical function layers 22.

### Modified Example 3

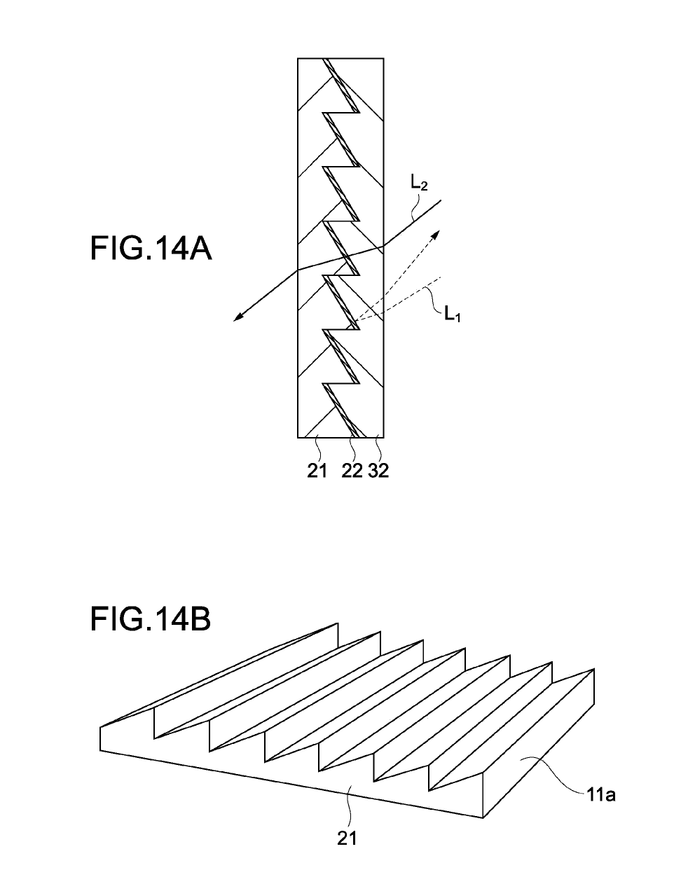

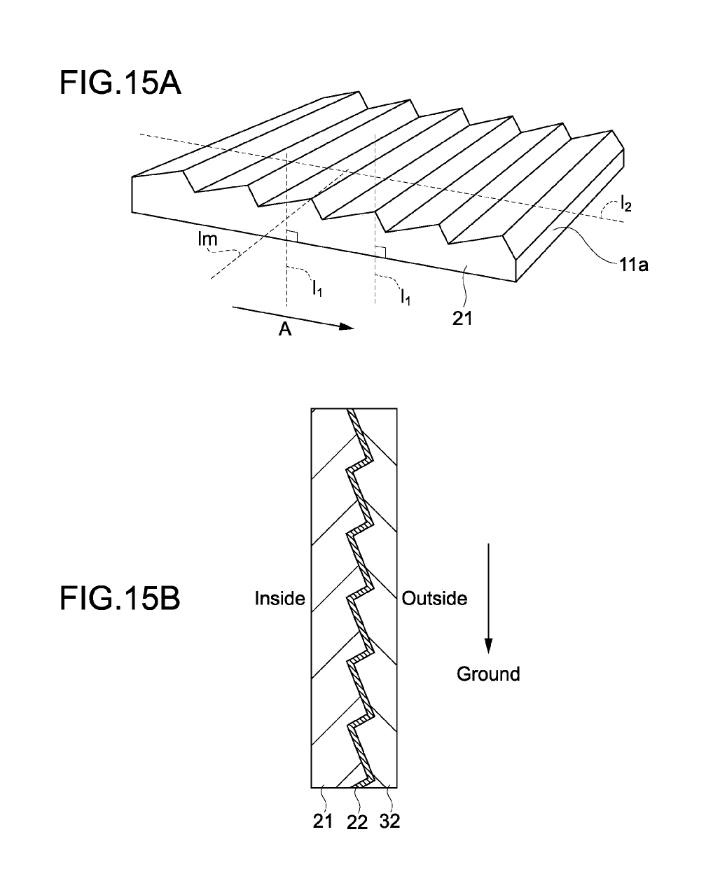

As shown in FIG. 15A, the structures 11a may have a shape asymmetrical to a vertical line l₁ perpendicular to the incident surface or the output surface. In this case, the principal axis lₘ of the structures 11a is inclined in an array direction thereof with respect to the line l₁. Here, the principal axis lₘ of the structures 11a is intended to indicate a line which passes through the peak of the structures 11a and the center of the bottom line of the cross-section of the structures 11a. When the optical laminated product 1 is used as a window material located substantially perpendicular to the ground, as shown in FIG. 15B, it is preferable that the principal axis lₘ of the structures 11a be inclined with respect to the vertical line l₁ toward the ground. In general, heat flows into the room through the window material, the flow of heat reaches a peak in the early afternoon, and the height of the sun is larger than 45 degrees in the early afternoon. Therefore, the optical laminated product 1 thus formed can effectively reflect light entering at a high angle to the upward direction. In FIG. 15, the prism shape of the structures 11a is unsymmetrical to the vertical line l₁. Furthermore, regarding the structures 11a, the shape other than prism may be unsymmetrical to the vertical line l₁. For example, the corner-of-cube shape may be unsymmetrical to the vertical line l₁.

When the structures 11a has a shape of corner of cube, and the ridge R is large, it is preferable that the structures 11a be inclined in an upward direction, and in terms of suppressing reflection from a lower direction, the structures 11a be inclined in a downward direction. Light coming from the sun in the oblique direction hardly reaches deep sections of the optical laminated product 1. The shape of the entrance side of the optical laminated product 1 becomes of particular importance. Specifically, when the ridge R is large, the recursively-reflected light is reduced. Therefore, it is possible to suppress this phenomenon under the condition that the structures 11a are inclined in an upward direction. In the corner of cube, recursive reflection is caused by light reflected three times on a reflection surface. On the other hand, part of light reflected two times is reflected in a direction other than recursive reflection. This leaked light is reflected and goes back to the sky direction by corner of cube inclined in a ground direction. Furthermore, this may be inclined in any direction on the basis of the shape and utilization purpose.

### Modified Example 4

In this example, the optical laminated product 1 according to the modified example further has a self-cleaning effect layer having a self-cleaning effect (not shown) on one principal surface of the optical laminated product 1. For example, the self-cleaning effect layer has photocatalyst such as TiO₂. As described above, the optical laminated product 1 is configured to partially reflect light in a specific wavelength band. When the optical laminated product 1 is used in the open air outside or in a filthy room, scattering of light caused by dirt on the surface of the optical laminated product 1 deteriorates the partial reflection characteristics (for example, directional reflection characteristic). Therefore, it is preferable that the surface of the optical laminated product 1 be optically transmissive at all times, and the surface of the optical laminated product 1 be excellent in water-shedding property and hydrophilic property, and automatically exert a self purification effect. In this modified example, the incident surface of the optical laminated product 1 is provided with a water-shedding function, a hydrophilic function, and the like, by reason that the self-cleaning function layer is formed on the incident surface of the optical laminated product 1. Therefore, the optical laminated product 1 can prevent contamination of the incident surface, deterioration of partially-reflection property (for example, directional reflection property).

### Modified Example 5

This modified example is different from the above modified example in terms of the fact that an optical laminated product 6 is configured to perform directional reflection of light of a specific wavelength band in a specific direction, and to scatter light other than the light of a specific wavelength band. The optical laminated product 6 has a light scattering member configured to scatter incident light. For example, the light scattering member is provided on, at least, the surface or inside of the light-transmissive body 21 and the intermediate layer 32, or between the light-transmissive body 21 or the intermediate layer 32 and the optical function layer 22. When the optical laminated product 6 is applied as a window member, it is preferable that a light scatterer be provided on opposite side of the incident surface, by reason that the optical laminated product 6 loses directional reflection property under the condition that the light scatterer is provided on the same side as the incident surface.

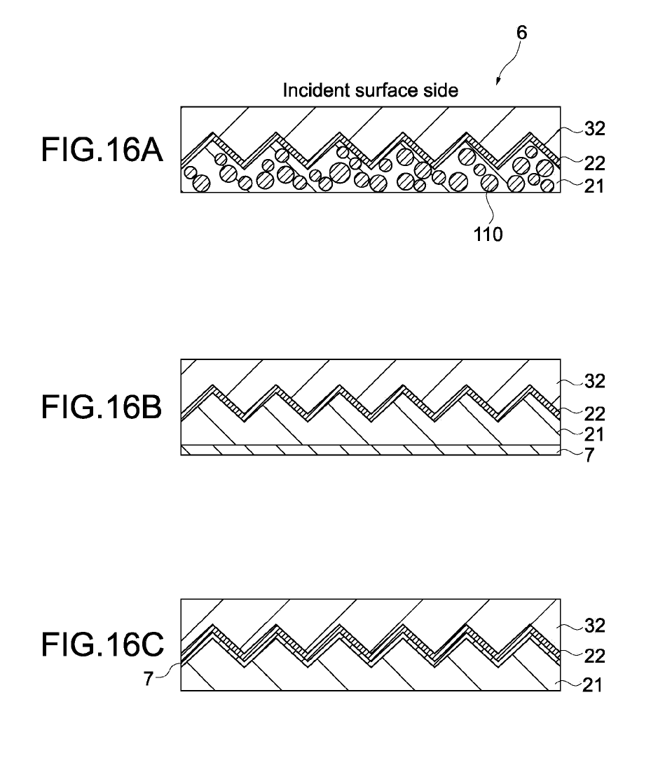

FIG. 16A is a cross-sectional view showing the first example of the configuration of the optical laminated product 6 according to this modified example. As shown in FIG. 16A, the light-transmissive body 21 formed on the opposite side of the incident surface has resin and fine particles 110. The fine particles 110 are different in refraction index from resin of the primary component of the light-transmissive body 21. The fine particles 110 may be composed of, for example, either or both organic and inorganic particles. Further, the fine particles 110 may be composed of hollow particles, and composed of inorganic particles made of silica, alumina or the like, or organic particles made of styrene, acrylic, their copolymer, or the like. Optimally, the fine particles 110 are made of silica.

FIGS. 16B and 16C are cross-sectional views showing the second and third configuration examples of the optical laminated product 6 according to this modified example. The optical laminated product 6 shown in FIG. 16B further has a light diffusion layer 7 on the rear surface of the light-transmissive body 21. On the other hand, the optical laminated product 6 shown in FIG. 16C further has a light diffusion layer 7 placed between the optical function layer 22 and the light-transmissive body 21. For example, the light diffusion layer 7 has the above-mentioned resin and fine particles.

In this modified example, the directional reflection of light of the specific wavelength band such as infrared light, and the diffusion of light other than light of the specific wavelength band such as visible light can be performed. Therefore, the smoked optical laminated product 6 is useful to have industrial design. Furthermore, when the incident surface is defined on the side of the light-transmissive body, the above-mentioned light diffusion layer is placed on the side of the intermediate layer 32. Furthermore, but not shown, the light diffusion layer may be provided in the intermediate layer 31, the intermediate layer 32, the base member 11, the base member 12, or interfaces of those members.

### Modified Example 6

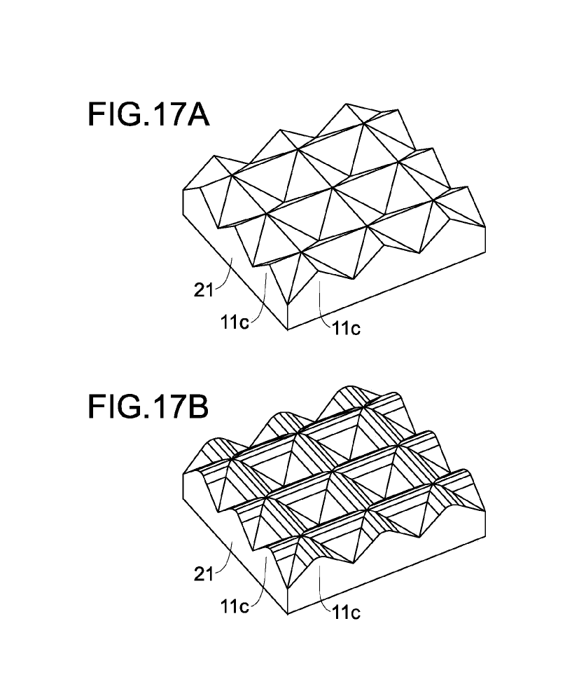

FIGS. 17 to 19 are cross-sectional views showing a modified example of a structure of the optical laminated product according to an embodiment.

In one mode of this modified example, as shown in FIGS. 17A and 17B, for example, orthogonally-arranged columnar first structures 11c (columnar object) are formed on one principal surface of the light-transmissive body 21. More specifically, the first structures 11c arranged in the first direction pass through side surfaces of second structures 11c arranged in the second direction perpendicular to the first direction, while the second structures 11c arranged in the second direction pass through side surfaces of the first structures 11c arranged in the first direction. The columnar structure 11c is a concave or convex section having for example prism, lenticular, or columnar shape.

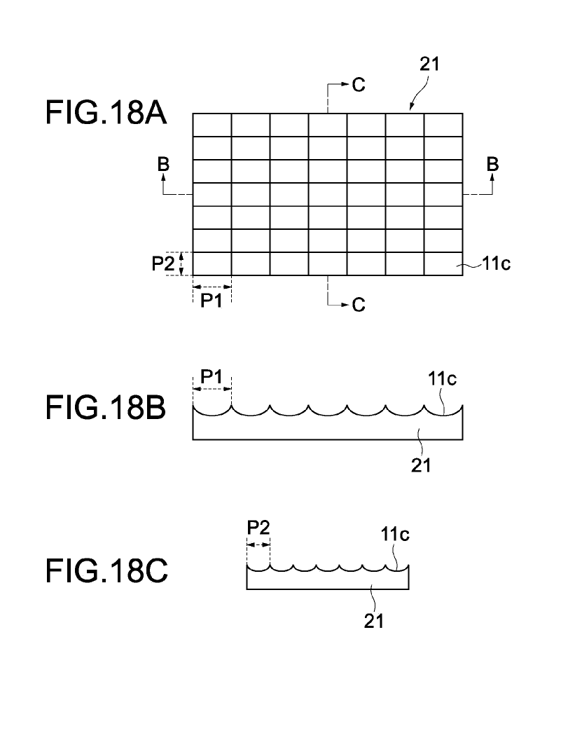

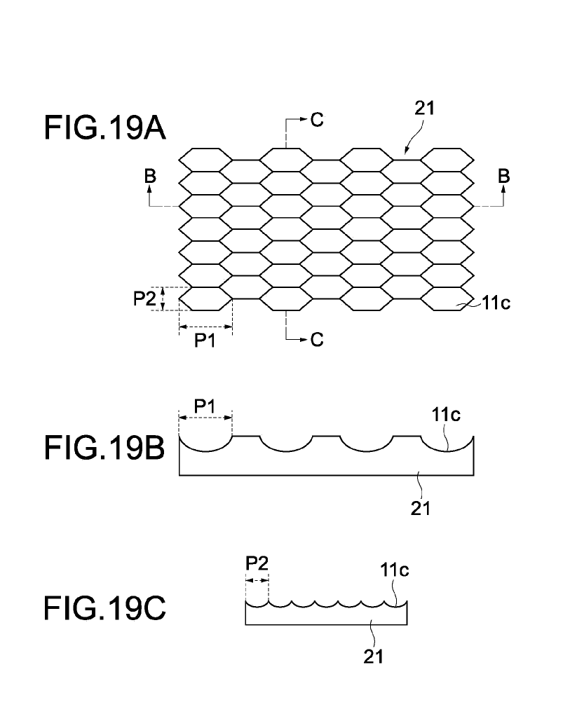

For example, it is possible to two-dimensionally arrange structures 11c, each of which has the shape of spherical, corner of cube or the like, on one principal surface of the light-transmissive body 21 to form close-packed array such as regular close-packed array, delta close-packed array, and hexagonal close-packed array. Regarding regular closed-packed array, as shown in FIGS. 18A to 18C, the structures 11c, each of which has a quadrangular-shaped (for example square-shaped) bottom surface, are arranged in the form of regular closed-packed structure. Regarding hexagonal close-packed array, as shown in FIG. 19A to 19C, the structures 11c, each of which has a hexagonal-shaped bottom surface, are arranged in the form of hexagonal close-packed structure.

Hereinafter, application examples will be described.

### Application Example 1

Although in the above-mentioned embodiments, the case where the optical laminated product according to the embodiments is applied to the window material or the like has been described as an example, the optical laminated product according to the embodiments may be used in combination with an interior member, an exterior member, or the like.

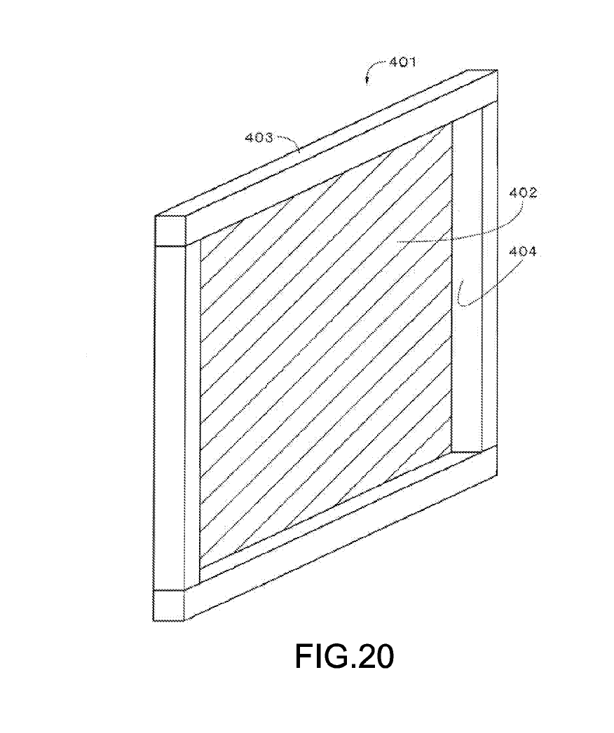

FIG. 20 is a perspective view showing an example of a configuration of a fitting (interior member or exterior member) according to this application example. As shown in FIG. 20, the fitting 401 has such a configuration that an optical laminated product 402 is provided in a light entrance portion 404. Specifically, the fitting 401 includes an optical laminated product 402 and a frame material 403 provided in a peripheral portion of the optical laminated product 402. The optical laminated product 402 is fixed through the frame material 403. Furthermore, the optical laminated product 402 is removable on needs. The fitting 401 may be applicable to various fittings, each of which has a light entrance portion. As the optical laminated product 402, the optical function products according to the above-mentioned embodiments or the modified examples are applicable.

### Application Example 2

The optical laminated product according to one embodiment may be used as a laminated glass. In this case, the intermediate layer is provided between the optical function layer and each glass, and functions as an adhesion layer by being subjected to thermal compression bonding or the like. The intermediate layer may be made of, for example, polyvinyl butyral (PVB). It is preferable that the laminated glass also have an antiscattering function just in a case the laminated glass is damaged. This laminated glass may be used as a vehicular window. In this case, because heat ray is reflected by the optical function layer, it is possible to prevent the sharp rise of in-vehicle temperature. This laminated glass is widely used for all transportation means such as vehicle, electric train, air plane, boats and ships, and rides in theme park, and may be curved on the intended use. In this case, it is preferable that the curved optical body have adaptability to the curve of glass to have certain directional reflection property and transmissive property. In general, the laminated glass is necessary to have transparency in some degree. Therefore, it is preferable that material (for example resin) of the intermediate layer be the same in refractive index or close to resin of the optical body. On the other hand, without having an intermediate layer, resin contained in the light-transmissive body may be double as an adhesive layer to glass. In this case, it is preferable to selectively use resin to ensure that the light-transmissive body made of that resin is maintained in shape without being deteriorated in shape in a thermal compression bond step or the like. Two base members facing each other are not limited in material to glass, either or both of these base members are made of resin film, sheet, plate, or the like, and may be made of, for example, lightweight, strong, and flexible engineering plastic material or reinforced plastic material. The laminated glass is not limited to in-vehicle application.

Furthermore, two or more of the above embodiments, practical examples, modified examples, and application examples of the applications may be combined.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An optical laminated product comprising:
a first transmissive base member;
a second transmissive base member facing the first transmissive base member; and
a structured layer arranged between the first transmissive base member and the second transmissive base member, and configured to perform directional reflection of light which forms part of light passed through the second transmissive base member.

2. The optical laminated product according to claim 1, wherein
the light passed through the second transmissive base member includes at least a first wavelength band and a second wavelength band different from the first wavelength band, and
the structured layer is configured to perform directional reflection of light in the first wavelength band, and configured to have light in the second wavelength band passed therethrough.

3. The optical laminated product according to claim 2, wherein
the structured layer has a light-transmissive body having a first surface on which directional reflective concave sections are arranged, and
an optical function layer formed on the first surface, and configured to reflect the light in the first wavelength band, and to have the light in the second wavelength band passed therethrough.

4. The optical laminated product according to claim 3, wherein
the light-transmissive body further has a second surface defined on the opposite side of the first surface,
the optical laminated product further comprises a first transmissive adhesion layer configured to have the second surface adhered to the first transmissive base member.

5. The optical laminated product according to claim 4, further comprising a second transmissive adhesion layer configured to have the structured layer adhered to the second transmissive base member.

6. The optical laminated product according to claim 4, further comprising a layer made of inactive gas sealed in between the structured layer and the second transmissive base member.

7. The optical laminated product according to claim 1, wherein
the first transmissive base member and the second transmissive base member are respectively made of glass substrates.

8. The optical laminated product according to claim 2, wherein
the first wavelength band is an infrared light range, and
the second wavelength band is a visible light range.

9. The optical laminated product according to claim 2, which is configured to selectively and directionally reflect the light in the first wavelength band which forms part of light entering an incident surface at an incident angle (θ, φ), in a direction other than a regular reflection angle (−θ, φ+180 degrees), and configured to have the light in the second wavelength band different from the first wavelength band passed therethrough, wherein
“θ” is an angle between a line vertical to the incident surface and the light entering the incident surface or light reflected from the incident surface, and
“φ” is an angle between a specific line on the incident surface and a projected component of the incident light or the reflected light to the incident surface.

10. The optical laminated product according to claim 9, wherein
a value of transmission image clarity measured using an optical comb of 0.5 mm in conformity with JIS (Japanese Industrial Standards) K-7105, is equal to or larger than 50 for the light of transmission wavelengths.

11. The optical laminated product according to claim 9, wherein
a total of values of transmission image clarity measured using optical combs of 0.125 mm, 0.5 mm, 1.0 mm, and 2.0 mm in conformity with JIS (Japanese Industrial Standards) K-7105, is equal to or larger than 230 for the light of transmission wavelengths.

12. The optical laminated product according to claim 9, wherein
an angle “φ” of a direction of the directional reflection to the light of the first wavelength band is equal to or larger than −90 degrees, and equal to or smaller than 90 degrees.

13. The optical laminated product according to claim 9, wherein
a direction of the directional reflection to the light of the first wavelength band is close to an angle of (θ, −φ).

14. The optical laminated product according to claim 9, wherein
a direction of the directional reflection to the light of the first wavelength band is close to an angle of (θ, φ).

15. The optical laminated product according to claim 1, wherein
the structured layer is a semi-transmissive layer.

16. The optical laminated product according to claim 1, wherein
the structured layer includes a plurality of structured layers inclined with respect to the incident surface of light, and
the plurality of structured layers are arranged parallel to each other.

17. The optical laminated product according to claim 1, wherein
the structured layer has a structure having one of a shape of prism, cylinder, hemisphere, and corner cube.

18. The optical laminated product according to claim 17, wherein
the structure is arranged as one or two-dimensional structure, and
the structure has a main axis inclined in an array direction of the structure with respect to a perpendicular line of the incident surface.

19. The optical laminated product according to claim 1, wherein
an absolute value of a difference of chromatic coordinates “x” and an absolute value of a difference of chromatic coordinates “y” of light entered through one of surfaces of the optical laminated product at an incident angle which is equal to or larger than 5 degrees and equal to or smaller than 60 degrees, and regularly reflected by the optical laminated product, are equal to or smaller than 0.05 in each of the surfaces of the optical laminated product.

20. The optical laminated product according to claim 1, further comprising
one of a water-shedding layer and a hydrophilic layer on one principal surface of the optical laminated product.

21. A fitting comprising
a light entrance portion provided with the optical laminated product according to claim 1.
